(19) United States
(12) Patent Application Publication
(10) Pub. No.: US 2026/0285611 A1
(43) Pub. Date: Sep. 24, 2026

(54) CONVEYOR BELT CLEANING ASSEMBLIES FOR CONVEYOR BELT ASSEMBLIES

(71) Applicant: Martin Engineering Company, Neponset, IL (US)

(72) Inventors: Lucas Pereira de Carvalho, Campinas (BR); Marco Antonio Monica, Paulínia (BR)

(73) Assignee: Martin Engineering Company, Neponset, IL (US)

(21) Appl. No.: 19/548,479

(22) Filed: Feb. 24, 2026

Related U.S. Application Data
(60) Provisional application No. 63/773,640, filed on Mar. 18, 2025.

(51) Int. Cl. B65G 45/12; B65G 45/26

(52) U.S. Cl. CPC B65G 45/12; B65G 45/26; B65G 2207/30

(57) ABSTRACT

Disclosed herein is a conveyor belt cleaning assembly including a leading cartridge segment including a rear engaging portion, a plurality of trailing cartridge segments, each trailing cartridge segment including a front engaging portion and a rear engaging portion opposite the front engaging portion, and a plurality of cleaning blades, each cleaning blade coupled to a respective one of the trailing cartridge segments. The rear engaging portion of the leading cartridge segment engages with the front engaging portion of one of the trailing cartridge segments and the front engaging portion of one of the trailing cartridge segments engages with the rear engaging portion of an adjacent one of the trailing cartridge segments.

### CROSS-REFERENCE TO RELATED APPLICATION

This application claims the benefit of co-pending U.S. Provisional Patent Application No. 63/773,640, filed Mar. 18, 2025, for “Conveyor Belt Cleaning Assemblies For Conveyor Belt Assemblies,” which is hereby incorporated by reference in its entirety including the drawings.

### TECHNICAL FIELD

The present specification generally relates to conveyor assemblies and/or methods for cleaning conveyor belts and, more specifically, conveyor belt cleaning assemblies for cleaning a surface of a conveyor belt.

### BACKGROUND

Conveyor belts are widely used in industrial and commercial environments to transport bulk materials or discrete products. However, material frequently adheres to conveyor belt surfaces, leading to issues such as product contamination, belt misalignment, and potential equipment damage. To address these issues, various belt cleaning solutions have been proposed in the past. Nonetheless, these existing solutions often require complex installation procedures and/or do not adequately accommodate the quick replacement of worn cleaning components.

Accordingly, a need exists for improved conveyor belt cleaning assemblies that clean a conveyor belt by removing material stuck on the conveyor belt.

### SUMMARY

In one embodiment, a conveyor belt cleaning assembly includes a leading cartridge segment including a rear engaging portion, a plurality of trailing cartridge segments, each trailing cartridge segment including a front engaging portion and a rear engaging portion opposite the front engaging portion, and a plurality of cleaning blades, each cleaning blade coupled to a respective one of the trailing cartridge segments. The rear engaging portion of the leading cartridge segment engages with the front engaging portion of one of the trailing cartridge segments and the front engaging portion of one of the trailing cartridge segments engages with the rear engaging portion of an adjacent one of the trailing cartridge segments.

In another embodiment, a conveyor belt assembly includes a chute, a conveyor belt extending within the chute, and a conveyor belt cleaning assembly positioned within and attached to the chute. The conveyor belt cleaning assembly includes a leading cartridge segment including a rear engaging portion, a plurality of trailing cartridge segments, each trailing cartridge segment including a front engaging portion and a rear engaging portion opposite the front engaging portion, and a plurality of cleaning blades, each cleaning blade coupled to a respective one of the trailing cartridge segments and contacting an outer surface of the conveyor belt. The rear engaging portion of the leading cartridge segment engages with the front engaging portion of one of the trailing cartridge segments and the front engaging portion of one of the trailing cartridge segments engages with the rear engaging portion of an adjacent one of the trailing cartridge segments.

In yet another embodiment, a method for assembling a conveyor belt cleaning assembly is provided. The method includes coupling a plurality of trailing cartridge segments to one another by engaging a rear engaging portion of one of the trailing cartridge segments with a front engaging portion of an adjacent one of the trailing cartridge segments, coupling the trailing cartridge segments to a leading cartridge segment by engaging a rear engaging portion of the leading cartridge segment with a front engaging portion of one of the trailing cartridge segments, coupling a cleaning blade to each of the trailing cartridge segments, sliding the leading cartridge segment and the plurality of trailing cartridge segments onto a mainframe tube, and adjusting a front mounting member and a rear mounting member to set a vertical position of the mainframe tube.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a perspective view of a conveyor belt assembly, according to one or more embodiments shown and described herein;

FIG. 2 schematically depicts a conveyor belt cleaning assembly of the conveyor belt assembly, according to one or more embodiments shown and described herein;

FIG. 3A schematically depicts a front perspective view of a leading cartridge segment of the conveyor belt cleaning assembly, according to one or more embodiments shown and described herein;

FIG. 3B schematically depicts a rear perspective view of the leading cartridge segment, according to one or more embodiments shown and described herein;

FIG. 4 schematically depicts a perspective view of a leading cartridge segment handle, according to one or more embodiments shown and described herein;

FIG. 5 schematically depicts a front perspective view of another embodiment of a leading cartridge segment, according to one or more embodiments shown and described herein;

FIG. 6 schematically depicts a front perspective view of a trailing cartridge segment of the conveyor belt cleaning assembly, according to one or more embodiments shown and described herein;

FIG. 7 schematically depicts a rear perspective view of the trailing cartridge segment, according to one or more embodiments shown and described herein;

FIG. 8 schematically depicts a perspective view of a blade attachment member, according to one or more embodiments shown and described herein;

FIG. 9 schematically depicts a front perspective view of a cleaning blade module, according to one or more embodiments shown and described herein;

FIG. 10 schematically depicts a rear perspective view of the cleaning blade module, according to one or more embodiments shown and described herein; and

FIG. 11 schematically depicts a perspective view of a cartridge segment assembly including the leading cartridge segment and a plurality of the trailing cartridge segments, according to one or more embodiments shown and described herein.

### DETAILED DESCRIPTION

Embodiments described herein are directed to a conveyor belt assembly that includes a conveyor belt, a chute, and a conveyor belt cleaning assembly for removing material from a surface of a conveyor belt.

The conveyor belt cleaning assembly includes a leading cartridge segment, a plurality of trailing cartridge segments, and a plurality of cleaning blades coupled to the trailing cartridge segments for removing material stuck on a surface of a conveyor belt. Various embodiments of the conveyor belt cleaning assembly and the operation of the conveyor belt cleaning assembly are described in more detail herein. Whenever possible, the same reference numerals will be used throughout the drawings to refer to the same or like parts.

Directional terms as used herein – for example up, down, right, left, front, back, top, bottom – are made only with reference to the figures as drawn and are not intended to imply absolute orientation.

In accordance with various embodiments, a conveyor belt assembly is positioned to facilitate the transport of material within an industrial environment or other application-specific setting. The conveyor belt assembly may be secured to adjacent support structures, and it is configured to direct material along a defined path.

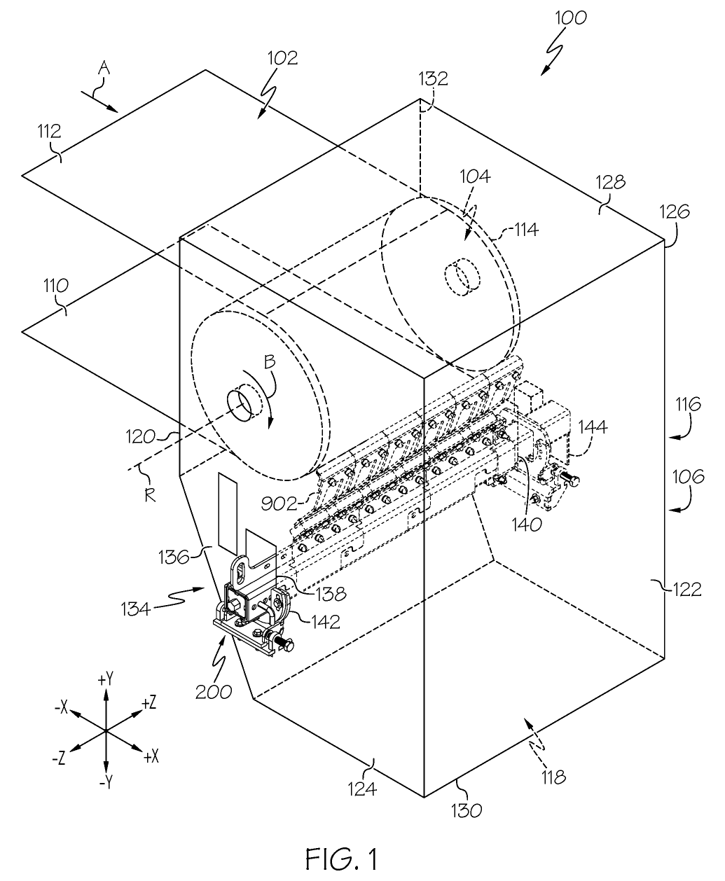

As used herein, the term “longitudinal direction” refers to the forward-rearward direction (i.e., in the +/- Z direction of the coordinate axes depicted in FIG. 1). The term “lateral direction” refers to the cross direction (i.e., in the +/- X direction of the coordinate axes depicted in FIG. 1), and is transverse to the longitudinal direction. The term “vertical direction” refers to the upward-downward direction (i.e., in the +/- Y direction of the coordinate axes depicted in FIG. 1). As used herein, “upper” and “above” are defined as the positive Y direction of the coordinate axes shown in the drawings. “Lower” and “below” are defined as the negative Y direction of the coordinate axes shown in the drawings.

Referring now to FIG. 1, a conveyor belt assembly 100 is illustrated according to one or more embodiments described herein. The conveyor belt assembly 100 may generally include a conveyor belt 102, a pulley 104, a chute 106, and a conveyor belt cleaning assembly 200. The conveyor belt 102, having an interior surface 110 and an exterior surface 112 opposite the interior surface 110, wraps around an exterior surface 114 of the pulley 104 and moves in the direction of arrow A. As such, the interior surface 110 of the conveyor belt 102 is in contact with the exterior surface 114 of the pulley 104. Although referred to as a pulley 104 herein, it should be appreciated that the pulley 104 may include any suitable roller device. In this embodiment, the conveyor belt 102 may be drawn in the direction of arrow A across the pulley 104 by another roller not shown. Alternatively, the pulley 104 may passively rotate in the direction of arrow B about a rotational axis R to facilitate movement of the conveyor belt 102 in the direction of arrow A. As such, the pulley 104 may be rotatably coupled to the chute 106 or some other mounting structure. In this embodiment, the exterior surface 114 of the pulley 104 may have a high coefficient of friction to grip the interior surface 110 of the conveyor belt 102 and assist in drawing the conveyor belt 102 in the direction of arrow A. In other embodiments, a motor or the like, not shown, may be provided for mechanically operating the pulley 104 and rotating the pulley 104 in the direction of arrow B to draw the conveyor belt 102 in the direction of arrow A.

As shown, the chute 106 includes a housing 116 having one or more walls defining an open interior 118. In embodiments, the one or more walls includes a front wall 120, a rear wall 122 opposite the front wall 120, a first side wall 124, a second side wall 126 opposite the first side wall 124, a top wall 128, and a bottom wall 130 opposite the top wall 128. An access port 132 is formed in the front wall 120 for permitting the conveyor belt 102 to enter and exit the open interior 118 of the chute 106. In embodiments, a lower portion 134 of the front wall 120 may define an inwardly tapered portion 136. As shown, the pulley 104 is at least partially positioned within the open interior 118 of the chute 106. As such, the portion of the conveyor belt 102 that is wrapped around the pulley 104 is also positioned within the open interior 118 of the chute 106. Although not shown, one or more of the front wall 120, the rear wall 122, the top wall 128, and the bottom wall 130 may include one or more openings for permitting material to enter and exit the chute 106. Embodiments may include a conveyor belt assembly 100 with no exterior walls.

In use, the conveyor belt 102 may be utilized for transporting material from one location to another. However, the material may become stuck to the surface of the conveyor belt 102 such that, if the material is not removed, the material may affect the performance of the conveyor belt 102 as it returns to collect additional material or transport additional product. Therefore, the conveyor belt cleaning assembly 200 is provided within the chute 106 for cleaning the exterior surface 112 of the conveyor belt 102 as it enters the chute 106 and before exiting the chute 106.

More particularly, in embodiments, a first window 138 may be formed in the first side wall 124 and a second window 140 may be formed in the second side wall 126. The conveyor belt cleaning assembly 200 may be insertable into the open interior 118 of the chute 106 through the first window 138 and the second window 140 and removably fixed in position to the chute 106 using one or more fasteners, such as screws, bolts, rivets, clips, clamps, or the like. As described in more detail herein, the conveyor belt cleaning assembly 200 may include a first mounting bracket 142 and a second mounting bracket 144 for fixing the conveyor belt cleaning assembly 200 to the first side wall 124 and the second side wall 126, respectively, on an outside surface thereof. The conveyor belt cleaning assembly 200 also includes one or more cleaning blades 902 positioned relative to the conveyor belt 102 to contact the exterior surface 112 of the conveyor belt 102 and dislodge or otherwise remove material therefrom as the conveyor belt 102 rotates across the pulley 104 and passes through the chute 106. As material is dislodged from the conveyor belt 102, the dislodged material is collected at a bottom portion of the chute 106.

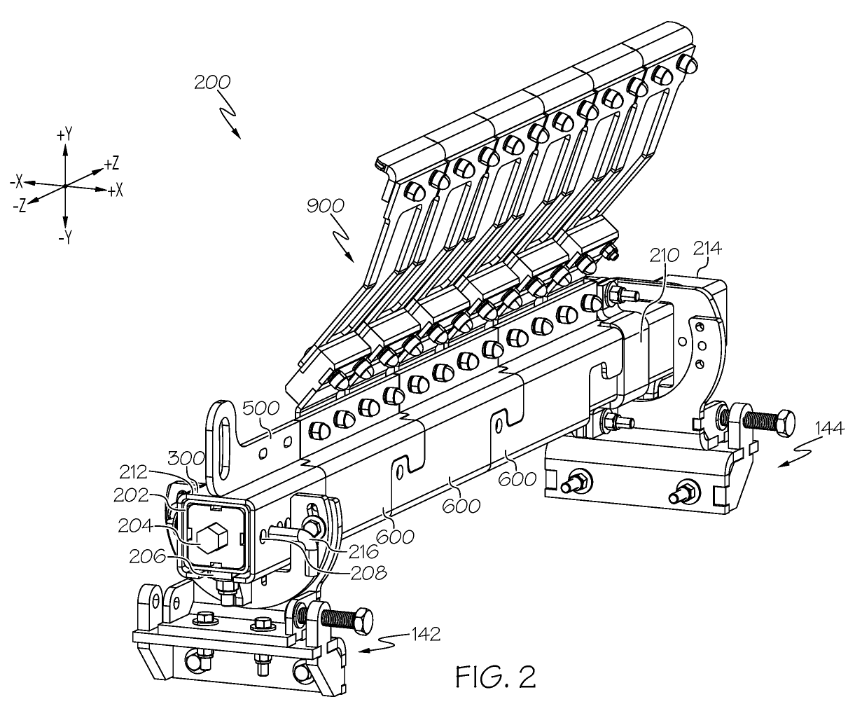

Referring now to FIG. 2, the conveyor belt cleaning assembly 200 is depicted in an arrangement that may be secured within or adjacent to the chute 106 for cleaning a conveyor belt 102 (FIG. 1). However, it should be appreciated that the conveyor belt cleaning assembly 200 may be utilized in combination with any other system or assembly other than that depicted in FIG. 1. The conveyor belt cleaning assembly 200 includes a leading cartridge segment 300, a segment handle 500, the first mounting bracket 142, the second mounting bracket 144, and at least one cleaning blade module 900. The first mounting bracket 142 is positioned on a first end 212 of the conveyor belt cleaning assembly 200, and the second mounting bracket 144 is disposed on a second end 214 of the conveyor belt cleaning assembly 200. The first end 212 of the conveyor belt cleaning assembly 200 is opposite the second end 214 of the conveyor belt cleaning assembly 200. The conveyor belt cleaning assembly 200 further includes a mainframe stop member 210, disposed proximate the second end of the conveyor belt cleaning assembly 200. The first mounting bracket 142 is configured to interact with at least the leading cartridge segment 300. In some embodiments, at least one of the first mounting bracket 142 and the second mounting bracket 144 may be configured to interact with one of a plurality of trailing cartridge segments 600 of a respective cleaning blade module 900. At least one of the first mounting bracket 142 and the second mounting bracket 144 may be configured to interact with the mainframe stop member 210 to stabilize or adjust the conveyor belt cleaning assembly 200 as needed.

Within the conveyor belt cleaning assembly 200, a mainframe tube 202 is provided to support the leading cartridge segment 300 and a plurality of trailing cartridge segments 600. The leading cartridge segment 300 and each trailing cartridge segment 600 has a square cross-sectional shape. The mainframe tube 202 includes a mainframe bolt 204 that is configured to be rotated for adjusting various parameters of the mainframe tube 202. Additionally, the mainframe tube 202 includes a mainframe protruding member 206, which may be a rail configured to support one or more trailing cartridge segments 600 or related components. The mainframe tube 202 also includes a mainframe locking hole 208. The mainframe locking hole 208 is configured to receive a locking member 216, such as a pin. This locking member 216 may have a bend of approximately 90 degrees to facilitate quick installation or removal.

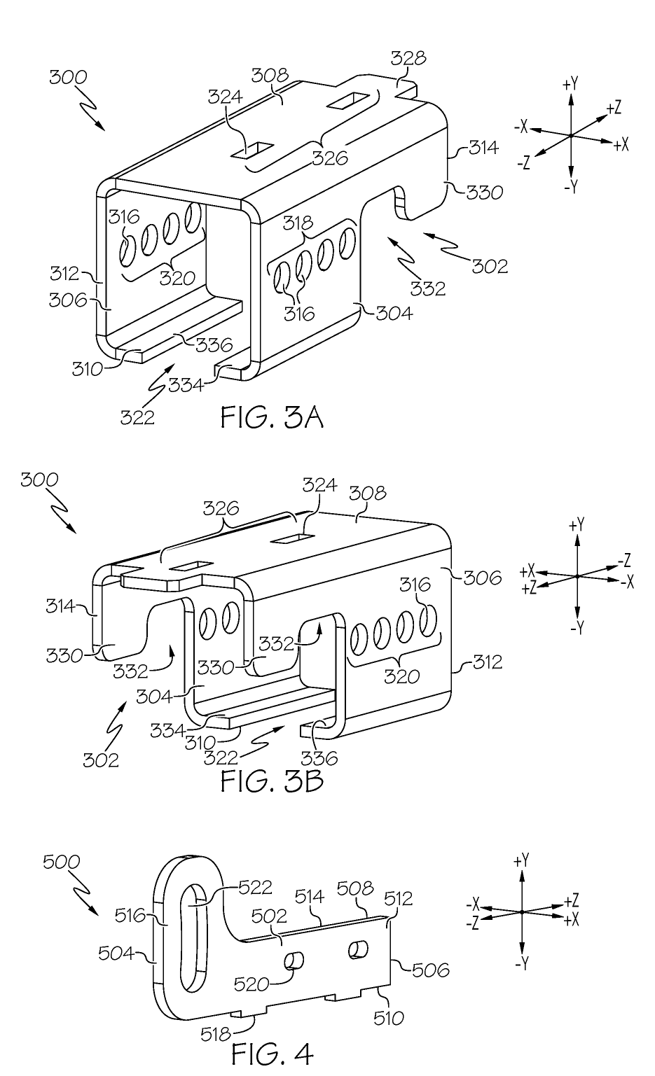

Referring now to FIGS. 3A and 3B, the leading cartridge segment 300 is illustrated in different orientations. The leading cartridge segment 300 includes a leading cartridge first side wall 304, a leading cartridge second side wall 306 opposite the leading cartridge first side wall 304, a leading cartridge upper wall 308 extending between the leading cartridge first side wall 304 and the leading cartridge second side wall 306, a leading cartridge lower wall 310, a leading cartridge first end 312, and a leading cartridge second end 314. The leading cartridge segment 300 is formed from any suitable material including, but not limited to, metals, such as steel or aluminum, or the like. Additionally, the leading cartridge segment 300 may be formed in any suitable manner, such as extrusion, specifically aluminum extrusion, laser cutting, machining, stamping, molding, additive manufacturing, and the like.

The leading cartridge first side wall 304 includes at least one leading cartridge locking hole 316 formed therein. The leading cartridge locking hole 316 is configured to receive a locking member 216 (FIG. 2) for securement purposes. The leading cartridge locking hole 316 may be configured to cooperate with the mainframe locking hole 208 of the mainframe tube 202. In such embodiments, the locking member 216 (FIG. 2) may be configured to extend through both the mainframe locking hole 208 and the leading cartridge locking hole 316 to secure the leading cartridge segment 300 to the mainframe tube 202.

As shown, the leading cartridge first side wall 304 includes a plurality of leading cartridge locking holes 316. The plurality of leading cartridge locking holes 316 may define a leading cartridge first locking hole array 318. The leading cartridge first locking hole array 318, as shown, is arranged linearly. In other embodiments, the leading cartridge first locking hole array 318 may have varying alignment. In even other embodiments, the leading cartridge first locking hole array 318 may form different patterns.

In embodiments, the leading cartridge second side wall 306 includes at least one leading cartridge locking hole 316 formed therein. The leading cartridge locking hole 316 is again configured to receive the locking member 216 (FIG. 2) for securement purposes. The leading cartridge locking hole 316 formed in the leading cartridge second side wall 306 may be configured to cooperate with the mainframe locking hole 208 of the mainframe tube 202. In such embodiments, the locking member 216 (FIG. 2) may be configured to extend through both the mainframe locking hole 208 and the leading cartridge locking hole 316.

As shown, the leading cartridge second side wall 306 includes a plurality of leading cartridge locking holes 316. The plurality of leading cartridge locking holes 316 may define a leading cartridge second locking hole array 320. The leading cartridge second locking hole array 320, as shown, is arranged linearly. In other embodiments, the leading cartridge second locking hole array 320 may have varying alignment. In even other embodiments, the leading cartridge second locking hole array 320 may form different patterns.

The leading cartridge upper wall 308 includes a leading cartridge protrusion 328. The leading cartridge protrusion 328 extends out from the leading cartridge second end 314, opposite the leading cartridge first end 312. The leading cartridge protrusion 328 extends out along the leading cartridge upper wall 308 and is shown as being rectangularly shaped. In other embodiments, the leading cartridge protrusion 328 may have any other suitable shape, such as circular or triangular. As shown, the leading cartridge upper wall 308 extends perpendicularly to both the leading cartridge first side wall 304 and the leading cartridge second side wall 306. In some embodiments, the leading cartridge upper wall 308 may extend at varying angles from at least one of the leading cartridge first side wall 304 or the leading cartridge second side wall 306. The leading cartridge upper wall 308 defines at least one leading cartridge finger slot 324 formed therein. As shown, the leading cartridge finger slots 324 are rectangular in shape. In other embodiments, one or more of the leading cartridge finger slots 324 may have varying shapes. For example, the leading cartridge finger slots 324 may be circular. The leading cartridge upper wall 308 may further include a plurality of the leading cartridge finger slots 324. The plurality of leading cartridge finger slots 324 define a leading cartridge finger slot array 326. The leading cartridge finger slot array 326, as shown, is linear. In other embodiments, the leading cartridge finger slot array 326 may have varying arrangements and patterns.

The leading cartridge lower wall 310 is disposed opposite from the leading cartridge upper wall 308. The leading cartridge lower wall 310 partially extends between both the leading cartridge first side wall 304 and the leading cartridge second side wall 306. As shown, the leading cartridge lower wall 310 extends perpendicularly from the leading cartridge first side wall 304 and the leading cartridge second side wall 306. In other embodiments, the leading cartridge lower wall 310 may extend at varying angles from at least one of the leading cartridge first side wall 304 or the leading cartridge second side wall 306. The leading cartridge lower wall 310 is defined by a lower surface first portion 334 and a lower surface second portion 336. The lower surface first portion 334 extends from the leading cartridge first side wall 304, while the lower surface second portion 336 extends from the leading cartridge second side wall 306. The combination of the lower surface first portion 334 and the lower surface second portion 336 defines a leading cartridge segment longitudinal slot 322. The leading cartridge segment longitudinal slot 322 is configured to interact with the mainframe protruding member 206 (FIG. 2). The leading cartridge segment longitudinal slot 322 may be configured to grip the mainframe protruding member 206. The fitting between the leading cartridge segment longitudinal slot 322 and the mainframe protruding member 206 may use friction to inhibit movement of the leading cartridge segment longitudinal slot 322 in relation to the mainframe protruding member 206. The location of the leading cartridge segment longitudinal slot 322 on the leading cartridge segment 300 and the location of the mainframe protruding member 206 on the mainframe tube 202 inhibit improper placement of the leading cartridge segment 300 onto the mainframe tube 202 during assembly of the conveyor belt cleaning assembly 200.

The leading cartridge first end 312 may be positioned distal to the mainframe stop member 210 (FIG. 2), while the leading cartridge second end 314 may be positioned proximal to the mainframe stop member 210. The leading cartridge second end 314 may define a leading cartridge rear engaging portion 302. The leading cartridge rear engaging portion 302 may be configured to interact with other segments, such as an adjacent one of the trailing cartridge segments 600 (FIG. 2). The leading cartridge rear engaging portion 302 includes a leading cartridge hook 330 defined by a leading cartridge recess 332. The leading cartridge hook 330, as depicted, extends in a downward vertical direction (e.g., -Y direction). In other embodiments, the leading cartridge hook 330 may extend in an upward vertical direction (e.g., +Y direction) opposite of the second vertical direction. In even other embodiments, the leading cartridge hook 330 may extend in various other directions.

Referring now to FIG. 4, the segment handle 500 is depicted for positioning of the leading cartridge segment 300 within the conveyor belt cleaning assembly 200. The segment handle 500 includes a segment handle body 502. The segment handle body 502 includes a segment handle front end 504, a segment handle rear end 506 opposite the segment handle front end 504, a segment handle upper surface 508, a segment handle lower surface 510 opposite the segment handle upper surface 508, a segment handle first side surface 512, and a segment handle second side surface 514 opposite the segment handle first side surface 512. The segment handle upper surface 508 extends between the segment handle front end 504 and the segment handle rear end 506. The segment handle lower surface 510 also extends between the segment handle front end 504 and the segment handle rear end 506. The segment handle first side surface 512 extends between the segment handle upper surface 508 and the segment handle lower surface 510. The segment handle second side surface 514 also extends between the segment handle upper surface 508 and the segment handle lower surface 510.

The segment handle body 502 includes one or more segment handle apertures 520. The segment handle apertures 520, as shown, are linearly aligned. The segment handle front end 504 is disposed distal to the mainframe stop member 210 (FIG. 2), while the segment handle rear end 506 is positioned proximal to the mainframe stop member 210. The segment handle body 502 further includes a segment handle grip 516 having a cutout 522 formed. The segment handle grip 516 is located adjacent to the segment handle front end 504. The segment handle grip 516, as depicted, has a round shape. In other embodiments, the segment handle grip 516 may be formed in other shapes, such as square or elliptical, or formed separately and attached to the segment handle body 502.

The segment handle upper surface 508 extends upward around the segment handle grip 516. The segment handle lower surface 510 is generally level around the segment handle grip 516 and defines one or more segment handle fingers 518. The segment handle fingers 518 are configured to be disposed within respective leading cartridge finger slots 324 of the leading cartridge segment 300 (FIG. 3A), so that the segment handle 500 may be attached or detached as needed. Once the segment handle 500 is positioned, it may be welded to the leading cartridge segment 300 to be fixed thereto.

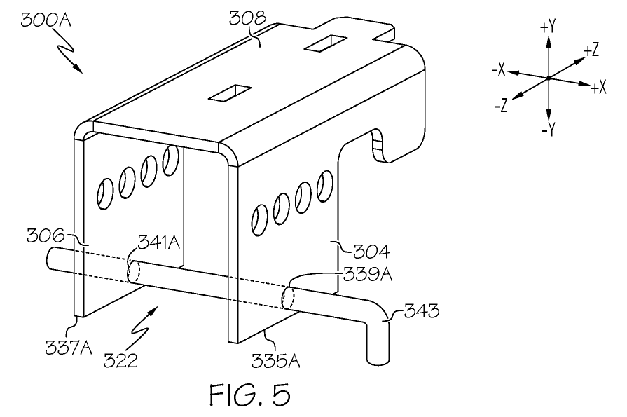

Referring now to FIG. 5, another embodiment of a leading cartridge segment 300A is illustrated. The leading cartridge segment 300A is substantially similar to the leading cartridge segment 300 illustrated in FIGS. 3A and 3B. As such like reference numbers will be used to refer to like parts. However, contrary to the leading cartridge segment 300 including the leading cartridge lower wall 310 defined by the lower surface first portion 334 and the lower surface second portion 336 extending toward one another, the leading cartridge segment 300A does not include the leading cartridge lower wall 310. Rather, the leading cartridge first side wall 304 and the leading cartridge second side wall 306 extend further than that depicted in FIGS. 3A and 3B with respect to the leading cartridge segment 300. Specifically, the leading cartridge first side wall 304 extends to a lower edge 335A opposite the leading cartridge upper wall 308, and the leading cartridge second side wall 306 extends to a lower edge 337A opposite the leading cartridge upper wall 308.

Additionally, at least one leading cartridge first retaining hole 339A is formed in the leading cartridge first side wall 304. As shown, only one leading cartridge first retaining hole 339A is formed in the leading cartridge first side wall 304. However, it should be appreciated that any number of leading cartridge first retaining holes 339A may be formed in the leading cartridge first side wall 304. The leading cartridge first retaining hole 339A is located proximate the lower edge 335A of the leading cartridge second side wall 306, e.g., closer to the lower edge 335A than to the leading cartridge upper wall 308. Similarly, at least one leading cartridge second retaining hole 341A is formed in the leading cartridge second side wall 306. As shown, only one leading cartridge second retaining hole 341A is formed in the leading cartridge second side wall 306. However, it should be appreciated that any number of leading cartridge second retaining holes 341A may be formed in the leading cartridge second side wall 306. The leading cartridge second retaining hole 341A is located proximate the lower edge 337A of the leading cartridge second side wall 306, e.g., closer to the lower edge 335A than to the leading cartridge upper wall 308.

As shown in FIG. 5, the leading cartridge first retaining hole 339A is coaxially aligned with the leading cartridge second retaining hole 341A. Stated another way, the leading cartridge first retaining hole 339A and the leading cartridge second retaining hole 341A are formed at the same longitudinal position along the Z-axis within the leading cartridge segment 300A. As such, a retaining member 343 may be inserted through the leading cartridge first retaining hole 339A and the leading cartridge second retaining hole 341A. In operation, with the leading cartridge segment 300A positioned on the mainframe tube 202 (FIG. 2) and the retaining member 343 inserted through the leading cartridge first retaining hole 339A and the leading cartridge second retaining hole 341A, the leading cartridge segment 300A is inhibited from being moved in the upward vertical direction (e.g., +Y direction). Once the retaining member 343 is removed from the leading cartridge first retaining hole 339A and the leading cartridge second retaining hole 341A of the leading cartridge segment 300A, the leading cartridge segment 300A is permitted to be removed from the mainframe tube 202.

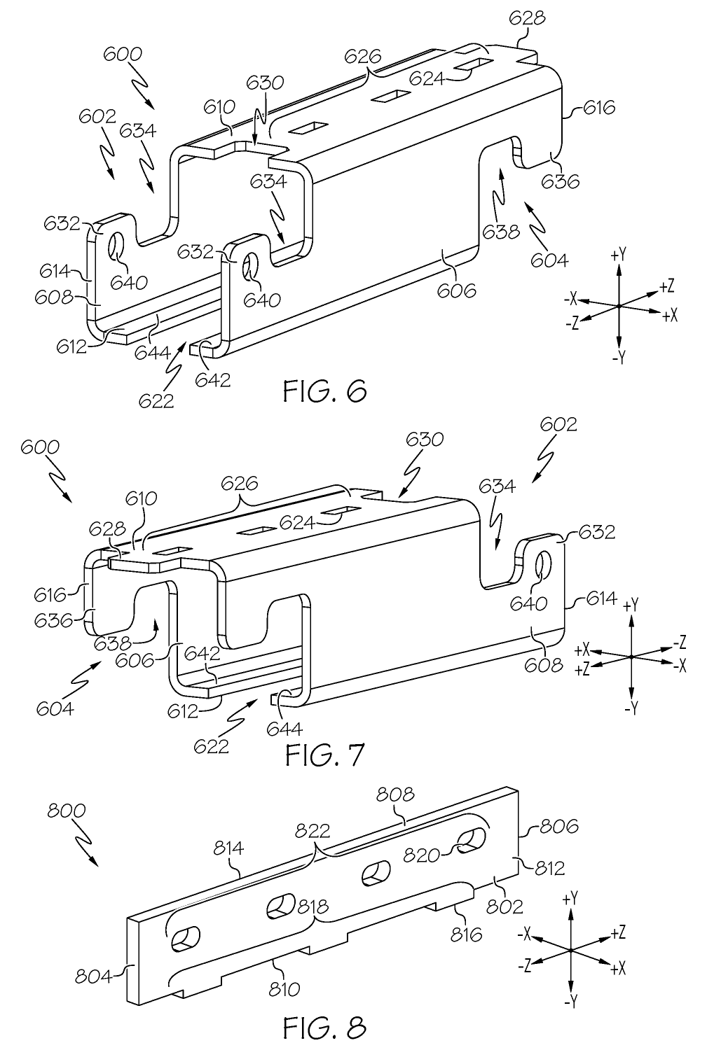

Referring now to FIGS. 6 and 7, one of the trailing cartridge segments 600 of the conveyor belt cleaning assembly 200 (FIG. 2) is illustrated. It should be appreciated that each trailing cartridge segment 600 is identical in structure. Thus, only one of the trailing cartridge segments 600 is described in detail herein. The trailing cartridge segment 600 includes a trailing cartridge first side wall 606, a trailing cartridge second side wall 608 opposite the trailing cartridge first side wall 606, a trailing cartridge upper wall 610 extending between the trailing cartridge first side wall 606 and the trailing cartridge second side wall 608, a trailing cartridge lower wall 612, a trailing cartridge first end 614, and a trailing cartridge second end 616 opposite the trailing cartridge first end 614. Similar to the leading cartridge segment 300, the trailing cartridge segment 600 is formed from any suitable material including, but not limited to, metals, such as steel or aluminum, or the like. Additionally, the trailing cartridge segment 600 may be formed in any suitable manner, such as extrusion, specifically aluminum extrusion, laser cutting, machining, stamping, molding, additive manufacturing, and the like.

In embodiments, the trailing cartridge first side wall 606 includes at least one trailing cartridge hook aperture 640 formed therein. In embodiments, the trailing cartridge second side wall 608 also includes at least one trailing cartridge hook aperture 640 formed therein. Both the trailing cartridge first side wall 606 and the trailing cartridge second side wall 608 may cooperate with the mainframe locking hole 208, so that in such embodiments, the locking member 216 (FIG. 2) may be configured to extend through the trailing cartridge hook aperture 640 in the trailing cartridge first side wall 606, through the mainframe locking hole 208, and then through the trailing cartridge hook aperture 640 in the trailing cartridge second side wall 608 to secure the trailing cartridge segment 600 to the mainframe tube 202.

As shown, the trailing cartridge upper wall 610 includes a trailing cartridge protrusion 628 and a trailing cartridge recess 630. The trailing cartridge protrusion 628 extends out from the trailing cartridge second end 616 along the trailing cartridge upper wall 610, and the trailing cartridge recess 630 extends into the trailing cartridge first end 614 along the trailing cartridge upper wall 610. The trailing cartridge protrusion 628 and the trailing cartridge recess 630 are shown as being rectangularly shaped. In other embodiments, the trailing cartridge protrusion 628 and the trailing cartridge recess 630 may have any other suitable shape, such as circular or triangular. As shown, the trailing cartridge upper wall 610 extends perpendicular to both the trailing cartridge first side wall 606 and the trailing cartridge second side wall 608. In some embodiments, the trailing cartridge upper wall 610 may extend at varying angles from at least one of the trailing cartridge first side wall 606 or the trailing cartridge second side wall 608. The trailing cartridge upper wall 610 defines at least one trailing cartridge finger slot 624 formed therein. As shown, the trailing cartridge finger slots 624 are rectangular in shape. In other embodiments, the trailing cartridge finger slots 624 may have varying shapes, such as circular. The trailing cartridge upper wall 610 may further include a plurality of trailing cartridge finger slots 624, which define a trailing cartridge finger slot array 626. The trailing cartridge finger slot array 626, as shown, is linear, although in other embodiments, it may have varying arrangements and patterns.

The trailing cartridge lower wall 612 is disposed opposite the trailing cartridge upper wall 610 and partially extends between both the trailing cartridge first side wall 606 and the trailing cartridge second side wall 608. As shown, the trailing cartridge lower wall 612 extends perpendicularly from the trailing cartridge first side wall 606 and the trailing cartridge second side wall 608. In other embodiments, the trailing cartridge lower wall 612 may extend at varying angles from at least one of the trailing cartridge first side wall 606 or the trailing cartridge second side wall 608. The trailing cartridge lower wall 612 is defined by a lower surface first portion 642 and a lower surface second portion 644. The lower surface first portion 642 extends from the trailing cartridge first side wall 606, while the lower surface second portion 644 extends from the trailing cartridge second side wall 608. The combination of the lower surface first portion 642 and the lower surface second portion 644 defines a trailing cartridge segment longitudinal slot 622. The trailing cartridge segment longitudinal slot 622 is configured to interact with the mainframe protruding member 206 (FIG. 2). The trailing cartridge segment longitudinal slot 622 may be configured to grip the mainframe protruding member 206, and the resulting friction fit may inhibit relative movement. The location of the trailing cartridge segment longitudinal slot 622 on the trailing cartridge segment 600 and the location of the mainframe protruding member 206 on the mainframe tube 202 inhibit improper placement of the trailing cartridge segment 600 onto the mainframe tube 202 during assembly of the conveyor belt cleaning assembly 200.

The trailing cartridge first end 614 may be positioned distal to the mainframe stop member 210, while the trailing cartridge second end 616 may be more proximal to the mainframe stop member 210. The trailing cartridge first end 614 may define a trailing cartridge front engaging portion 602, and the trailing cartridge second end 616 may define a trailing cartridge rear engaging portion 604. The trailing cartridge front engaging portion 602 includes a trailing cartridge front hook 632 and a trailing cartridge front recess 634. The trailing cartridge rear engaging portion 604 includes a trailing cartridge rear hook 636 and a trailing cartridge rear recess 638. The trailing cartridge front engaging portion 602 may be configured to interact with other segments, such as an adjacent one of the leading cartridge segments 300 (FIG. 2) or an adjacent one of the trailing cartridge segments 600. The trailing cartridge rear engaging portion 604 may be configured to interact with other segments, such as an adjacent one of the trailing cartridge segments 600. As depicted, the trailing cartridge front hook 632 extends in an upward vertical direction (e.g., +Y direction). In other embodiments, the trailing cartridge front hook 632 may extend in a downward vertical direction (e.g., -Y direction).

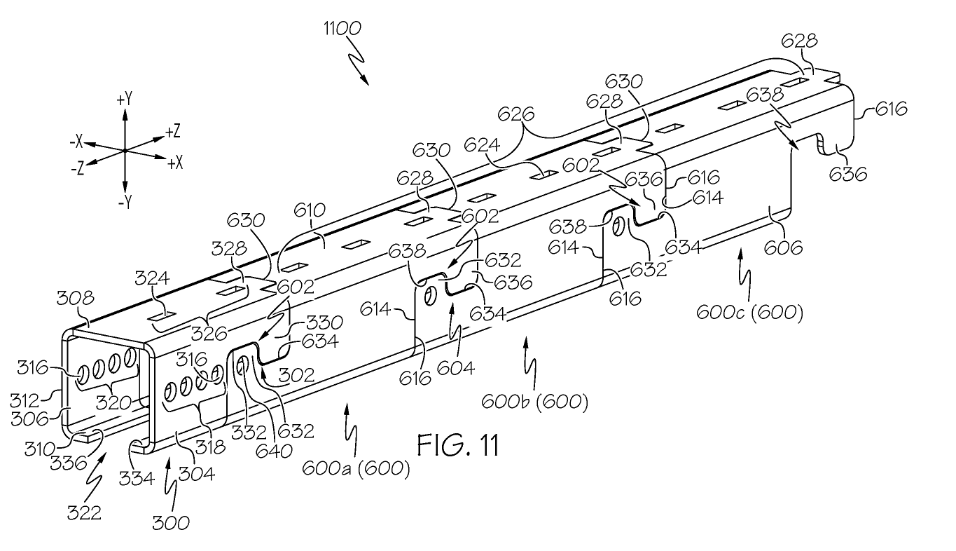

Similarly, the trailing cartridge rear hook 636, as depicted, extends in the upward vertical direction (i.e., +Y direction). In other embodiments, the trailing cartridge rear hook 636 may extend in the downward vertical direction (i.e., -Y direction). The trailing cartridge front engaging portion 602 and the trailing cartridge rear engaging portion 604 are mirror images of one another about the XZ plane. Additionally, the trailing cartridge front engaging portion 602 of the trailing cartridge segment 600 engages with the trailing cartridge rear engaging portion 604 of another trailing cartridge segment 600, allowing for a series of trailing cartridge segments 600 to be joined end-to-end and to form a cartridge segment assembly, as shown in FIG. 11. In embodiments, a width of the trailing cartridge front hook 632 extending in along the Z axis is equal to a width of the trailing cartridge rear hook 636 extending in along the Z axis, and a width of the trailing cartridge front recess 634 is equal to a width of the trailing cartridge rear recess 638. In embodiments, a width of the trailing cartridge front recess 634 extending in along the Z axis and a width of the trailing cartridge rear recess 638 extending in along the Z axis is slightly greater than the width of the trailing cartridge front hook 632 and the trailing cartridge rear hook 636 so that the trailing cartridge front hook 632 and the trailing cartridge rear hook 636 of one of the trailing cartridge segments 600 can fit into the trailing cartridge front recess 634 and the trailing cartridge rear recess 638 of an adjacent trailing cartridge segment 600.

Referring now to FIG. 8, a blade attachment member 800 is illustrated for coupling one or more of the cleaning blades 902 (FIG. 1). The blade attachment member 800 includes a blade attachment member body 802. The blade attachment member body 802 includes a blade attachment front end 804, a blade attachment rear end 806 opposite the blade attachment front end 804, a blade attachment member upper surface 808, a blade attachment member lower surface 810 opposite the blade attachment member upper surface 808, a blade attachment first side surface 812, and a blade attachment second side surface 814 opposite the blade attachment first side surface 812. The blade attachment member upper surface 808 extends between the blade attachment front end 804 and the blade attachment rear end 806. The blade attachment member lower surface 810 also extends between the blade attachment front end 804 and the blade attachment rear end 806. The blade attachment first side surface 812 extends between the blade attachment member upper surface 808 and the blade attachment member lower surface 810. The blade attachment second side surface 814 likewise extends between the blade attachment member upper surface 808 and the blade attachment member lower surface 810.

In embodiments, the blade attachment member body 802 includes one or more blade attachment fingers 816 and one or more blade attachment member apertures 820. As shown, a plurality of blade attachment fingers 816 are linearly aligned in a blade attachment finger array 818. In other embodiments, the blade attachment finger array 818 may have varying alignment to accommodate different attachment embodiments. As shown, a plurality of blade attachment member apertures 820 are linearly aligned in a blade attachment member aperture array 822. In other embodiments, the blade attachment member aperture array 822 may have varying alignment to accommodate different attachment embodiments. The blade attachment fingers 816 are configured to be disposed within respective trailing cartridge finger slots 624 of the trailing cartridge segment 600 (FIG. 6), so that the blade attachment member 800 may be attached or detached as needed. Once the blade attachment member 800 is positioned, at any suitable angular orientation, the blade attachment member 800 may be welded to the trailing cartridge segment 600 to be fixed thereto.

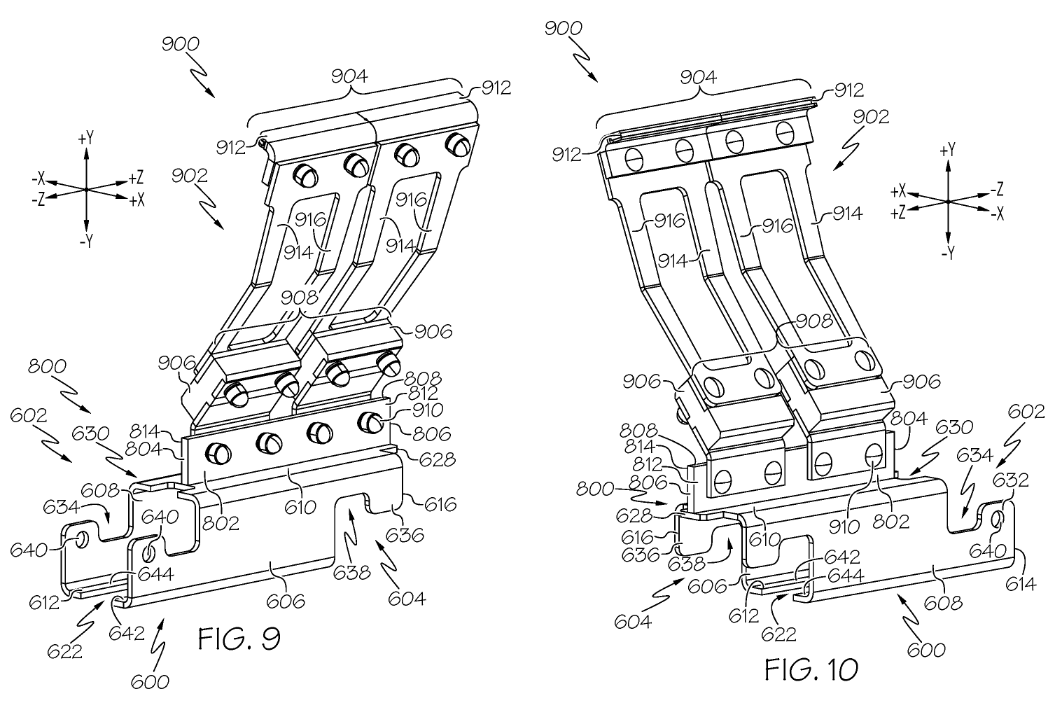

Referring now to FIGS. 9 and 10, one of the cleaning blade modules 900 is depicted. It should be appreciated that each cleaning blade module 900 is identical in structure. Thus, only one of the cleaning blade modules 900 is described in detail herein. The cleaning blade module 900 includes the cleaning blades 902 coupled to a blade attachment member 800, which is mounted to a trailing cartridge segment 600. Additionally, the cleaning blade module 900 includes a pair of cleaning blade support members 906 for coupling the cleaning blades 902 to the blade attachment member 800, and a cleaning blade engagement member 912 provided at an opposite end of each of the cleaning blades 902. The cleaning blade engagement member 912 is used to scrape debris from the exterior surface 112 of a conveyor belt 102 (FIG. 1) or similar moving surface by disposing the cleaning blades 902 adjacent to the conveyor belt 102 and actuating a conveyor motor of the conveyor belt assembly 100 to move the conveyor belt 102 across the cleaning blades 902. A cleaning blade first support arm 914 and a cleaning blade second support arm 916 may be used to support the cleaning blade engagement member 912. Each of the cleaning blade first support arm 914 and the cleaning blade second support arm 916 may extend from the cleaning blade engagement member 912 to the cleaning blade support member 906.

As described herein, the cleaning blade module 900 includes a pair of cleaning blades 904 positioned for enhanced cleaning coverage. Each of the pair of cleaning blades 904 includes a cleaning blade support member 906, thus allowing multiple blades to be anchored in place. The cleaning blade module 900 includes several cleaning blade support members 906, and these multiple cleaning blade support members 906 define a plurality of cleaning blade support members 908. Each cleaning blade support member 906 is configured to attach the cleaning blade 902 to a blade attachment member 800 or other mounting structure. The elements of the cleaning blade 902 may be removably attached to one another using cleaning blade attachment fasteners 910. However, it should be appreciated that each cleaning blade module 900 may include any number of cleaning blades 902, such as one cleaning blade 902 or more than two cleaning blades 902.

Referring now to FIG. 11, a cartridge segment assembly 1100 is shown in which the leading cartridge segment 300 is combined with the plurality of trailing cartridge segments 600. As shown, the cartridge segment assembly 1100 includes the plurality of trailing cartridge segments 600 arranged in series. In other embodiments, the cartridge segment assembly 1100 may include only a single trailing cartridge segment 600. In even further embodiments, the cartridge segment assembly 1100 may include only the leading cartridge segment 300 without any trailing cartridge segments 600. Each trailing cartridge segment includes an upper wall defining a recess formed in a front end of the upper wall and a protrusion formed in a rear end of the upper wall opposite the front end. The protrusion of the leading cartridge segment 300 engages the recess of the trailing cartridge segment 600 adjacent to the leading cartridge segment 300. The protrusion of one of the trailing cartridge segments engages the recess of an adjacent one of the trailing cartridge segments.

As shown, the plurality of trailing cartridge segments 600 includes a first trailing cartridge segment 600a, a second trailing cartridge segment 600b, and a third trailing cartridge segment 600c. The trailing cartridge front engaging portion 602 of the first trailing cartridge segment 600a engages the leading cartridge rear engaging portion 302 of the leading cartridge segment 300. Specifically, the leading cartridge hook 330 is received within the trailing cartridge front recess 634 and the leading cartridge recess 332 receives the trailing cartridge front hook 632. The trailing cartridge rear engaging portion 604 of the first trailing cartridge segment 600a engages the trailing cartridge front engaging portion 602 of the second trailing cartridge segment 600b. Specifically, the trailing cartridge rear hook 636 of the first trailing cartridge segment 600a is received within the trailing cartridge front recess 634 of the second trailing cartridge segment 600b and the trailing cartridge front hook 632 of the second trailing cartridge segment 600b is received within the trailing cartridge rear recess 638 of the first trailing cartridge segment 600a. The trailing cartridge rear engaging portion 604 of the second trailing cartridge segment 600b engages the trailing cartridge front engaging portion 602 of the third trailing cartridge segment 600c. Specifically, the trailing cartridge rear hook 636 of the second trailing cartridge segment 600b is received within the trailing cartridge front recess 634 of the third trailing cartridge segment 600c and the trailing cartridge front hook 632 of the third trailing cartridge segment 600c is received within the trailing cartridge rear recess 638 of the second trailing cartridge segment 600b. In embodiments, additional coupling trailing cartridge segments may be provided between adjacent trailing cartridge segments 600. These coupling trailing cartridge segments may have similar, but not identical structure to the trailing cartridge segments 600 such as, for example, different lengths but similar engaging portions.

The trailing cartridge finger slot array 626 of the first trailing cartridge segment 600a aligns with the leading cartridge finger slot array 326 of the leading cartridge segment 300, and the trailing cartridge finger slot array 626 of the first trailing cartridge segment 600a also aligns with the trailing cartridge finger slot array 626 of the second trailing cartridge segment 600b. Together, the first trailing cartridge finger slot array 626, the second trailing cartridge finger slot array 626, and the leading cartridge finger slot array 326 combine to form a greater finger slot array. Additionally, the trailing cartridge segment longitudinal slot 622 of the first trailing cartridge segment 600a aligns with the leading cartridge segment longitudinal slot 322 of the leading cartridge segment 300, and the trailing cartridge segment longitudinal slot 622 of the first trailing cartridge segment 600a also aligns with the trailing cartridge segment longitudinal slot 622 of the second trailing cartridge segment 600b. In combination, the trailing cartridge segment longitudinal slot 622 of the first trailing cartridge segment 600a, the trailing cartridge segment longitudinal slot 622 of the second trailing cartridge segment 600b, and the leading cartridge segment longitudinal slot 322 define a greater longitudinal slot that extends through multiple segments.

From the above, it is to be appreciated that defined herein is a conveyor belt cleaning assembly for removing material from an exterior surface of a conveyor belt. The conveyor belt cleaning assembly includes a leading cartridge segment, a plurality of trailing cartridge segments, and a plurality of cleaning blade modules coupled to the trailing cartridge segments. This modular design of the conveyor belt cleaning assembly allows the removal of the leading cartridge segment and one or more of the trailing cartridge segments for any adjustment or repair without having to remove the entire cartridge segment assembly. Removal of an unsegmented conveyor belt cleaning assembly may be difficult or not possible given reduced clearance space outside of the chute.

While particular embodiments have been illustrated and described herein, it should be understood that various other changes and modifications may be made without departing from the scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A conveyor belt cleaning assembly comprising:
a leading cartridge segment including a rear engaging portion;
a plurality of trailing cartridge segments, each trailing cartridge segment including a front engaging portion and a rear engaging portion opposite the front engaging portion; and
a plurality of cleaning blades, each cleaning blade coupled to a respective one of the trailing cartridge segments;
wherein the rear engaging portion of the leading cartridge segment engages with the front engaging portion of one of the trailing cartridge segments; and
wherein the front engaging portion of one of the trailing cartridge segments engages with the rear engaging portion of an adjacent one of the trailing cartridge segments.

2. The conveyor belt cleaning assembly of claim 1, wherein the leading cartridge segment includes one or more side walls, a plurality of locking holes arranged in a linear array and formed in the one or more side walls.

3. The conveyor belt cleaning assembly of claim 1, wherein the front engaging portion of each trailing cartridge segment includes one or more front hooks extending in a first vertical direction.

4. The conveyor belt cleaning assembly of claim 3, wherein the rear engaging portion of each trailing cartridge segment includes one or more rear hooks extending in a second vertical direction opposite the first vertical direction, the rear hooks engaging the front hooks.

5. The conveyor belt cleaning assembly of claim 4, wherein each trailing cartridge segment includes an upper wall defining a recess formed in a front end of the upper wall and a protrusion formed in a rear end of the upper wall opposite the front end, the protrusion of one of the trailing cartridge segments engaging the recess of an adjacent one of the trailing cartridge segments.

6. The conveyor belt cleaning assembly of claim 1, wherein each trailing cartridge segment includes an upper wall defining one or more finger slots formed in the upper wall.

7. The conveyor belt cleaning assembly of claim 6, further comprising a plurality of blade attachment members each including one or more fingers, the one or more fingers of each blade attachment member received within respective finger slots.

8. The conveyor belt cleaning assembly of claim 7, wherein the cleaning blades are fixed to a respective blade attachment member to be coupled to a respective trailing cartridge segment.

9. The conveyor belt cleaning assembly of claim 1, wherein each trailing cartridge segment includes a lower wall defining a longitudinal slot extending from a front end of the lower wall and a rear end of the lower wall opposite the front end.

10. The conveyor belt cleaning assembly of claim 1, wherein the leading cartridge segment and each trailing cartridge segment has a square cross-sectional shape.

11. A conveyor belt assembly comprising:
a chute;
a conveyor belt extending within the chute; and
a conveyor belt cleaning assembly positioned within and attached to the chute, the conveyor belt cleaning assembly including:
a leading cartridge segment including a rear engaging portion;
a plurality of trailing cartridge segments, each trailing cartridge segment including a front engaging portion and a rear engaging portion opposite the front engaging portion; and
a plurality of cleaning blades, each cleaning blade coupled to a respective one of the trailing cartridge segments and contacting an outer surface of the conveyor belt;
wherein the rear engaging portion of the leading cartridge segment engages with the front engaging portion of one of the trailing cartridge segments; and
wherein the front engaging portion of one of the trailing cartridge segments engages with the rear engaging portion of an adjacent one of the trailing cartridge segments.

12. The conveyor belt assembly of claim 11, wherein the leading cartridge segment includes one or more side walls, a plurality of locking holes arranged in a linear array, and wherein the plurality of locking holes is formed in the one or more side walls.

13. The conveyor belt assembly of claim 11, wherein the front engaging portion of each trailing cartridge segment includes one or more front hooks extending in a first vertical direction.

14. The conveyor belt assembly of claim 13, wherein the rear engaging portion of each trailing cartridge segment includes one or more rear hooks extending in a second vertical direction opposite the first vertical direction, the one or more rear hooks engaging the one or more front hooks.

15. The conveyor belt assembly of claim 11, wherein each trailing cartridge segment includes an upper wall defining a recess formed in a front end of the upper wall and a protrusion formed in a rear end of the upper wall opposite the front end, the protrusion of one trailing cartridge segment engaging the recess of an adjacent trailing cartridge segment.

16. The conveyor belt assembly of claim 11, wherein each trailing cartridge segment includes an upper wall defining one or more finger slots, and further comprising a plurality of blade attachment members each including one or more fingers, the one or more fingers of each blade attachment member received within respective finger slots, each cleaning blade being fixed to a respective blade attachment member.

17. The conveyor belt assembly of claim 11, wherein each trailing cartridge segment includes a lower wall defining a longitudinal slot extending from a front end of the lower wall to a rear end of the lower wall, and wherein the leading cartridge segment and each trailing cartridge segment has a square cross-sectional shape.

18. A method comprising:
coupling a plurality of trailing cartridge segments to one another by engaging a rear engaging portion of one of the trailing cartridge segments with a front engaging portion of an adjacent one of the trailing cartridge segments;
coupling the trailing cartridge segments to a leading cartridge segment by engaging a rear engaging portion of the leading cartridge segment with a front engaging portion of one of the trailing cartridge segments;
coupling a cleaning blade to each of the trailing cartridge segments;
sliding the leading cartridge segment and the plurality of trailing cartridge segments onto a mainframe tube; and
adjusting a front mounting member and a rear mounting member to set a vertical position of the mainframe tube.

19. The method of claim 18, further comprising:
disposing a conveyor belt of a conveyor belt assembly adjacent to the cleaning blades.

20. The method of claim 19, further comprising:
actuating a conveyor motor of the conveyor belt assembly to move the conveyor belt across the cleaning blade.
